(19) United States
(12) Patent Application Publication
(10) Pub. No.: US 2012/0044252 A1
(43) Pub. Date: Feb. 23, 2012

(54) IMAGE DISPLAY APPARATUS AND METHOD OF CONTROLLING THE SAME

(75) Inventors: Takashi Kamimura, Kawasaki-shi (JP); Hidenori Kanazawa, Mishima-shi (JP); Osamu Sagano, Inagi-shi (JP)

(73) Assignee: CANON KABUSHIKI KAISHA, Tokyo (JP)

(21) Appl. No.: 13/206,939

(22) Filed: Aug. 10, 2011

(30) Foreign Application Priority Data
Aug. 20, 2010 (JP) 2010-185288

(51) Int. Cl. G06T 1/60

(52) U.S. Cl. 345/530

(57) ABSTRACT

An image display apparatus includes an image processing circuit configured to generate an image signal based on input image data such that the image signal includes a main-image frame and a sub-image frame with luminance lower than that of the main-image frame. The image processing circuit includes a conversion circuit and a memory control circuit. The conversion circuit converts frame synchronization signals of respective frames such that the main-image frame has a longer horizontal scanning period than the sub-image frame. The memory control circuit switches, in a period in which the unconverted synchronization signal and the converted synchronization signal are both in a vertical blanking period, operation modes of two frame memories between writing and reading. The image display apparatus is capable of suppressing a visible disturbance in image quality and a reduction in the total image luminance of a moving image without increasing a frame memory transfer rate.

### BACKGROUND OF THE INVENTION

1. Field of the Invention

The present invention relates to an image display apparatus capable of controlling writing/reading image data to/from a frame memory.

2. Description of the Related Art

The image display apparatus can be classified into two types, i.e., an impulse-type display apparatus typified by a CRT display apparatus and a hold-type display apparatus typified by an LCD display apparatus. The impulse-type display apparatus can provide a high-quality moving image, but the image may include a perceivable flicker. On the other hand, in the hold-type display apparatus, flickers are inconspicuous. However, a motion blur can often occur.

Japanese Patent Laid-Open No. 2004-240317 discloses a technique of dividing one frame period into two sub periods. In the first sub period, pixel data is intensively written in pixels, and remaining image data with values greater than an upper limit allowed to be written in the first sub period is written in the second sub period whereby it becomes possible to achieve a hold-type display apparatus capable of displaying a high-quality moving image without reducing the total image luminance.

Japanese Patent Laid-Open No. 2002-351382 discloses a hold-type display apparatus in which the frame frequency of an image signal is set to be twice the normal value and the gain for high-frequency components of the image signal is adaptively changed depending on a motion detection signal thereby achieving high quality in a moving image without reducing the total image luminance.

In the impulse-type display apparatus, to suppress the flicker, if the frame frequency is increased and the same frame is simply displayed twice in succession, then a perceivable disturbance in image such as a motion blur can occur. Instead of simply displaying the same frame twice in succession, if one frame is displayed as a main image frame and the other frame is displayed as a sub image frame with a luminance different from that of the main image frame, then the disturbance can be suppressed. However, in a case where the gray level is controlled by pulse-width modulation of a modulating signal, a reduction in the total image luminance can occur because of the limitation on the frame period for each divided frame.

One method of improving the situation described above is to set horizontal scanning periods of respective frames such that the horizontal scanning period of the main-image frame is longer than the horizontal scanning period of the sub-image frame. This method may be practiced by configuring the image processing circuit such that two frame memories are provided and operation modes of these two memories are switched every frame such that when one frame memory is in a write or read mode, the other frame memory is in the other mode. This method is known as a dual buffer method.

This method has some problems as described below. FIG. 10 illustrates timings of writing/reading data to/from frame memories for a case where a main image is set to have higher luminance than a sub image. In the writing operation, the frame periods of the main image and the sub image are set to be equal in length. However, in the reading operation, the main image has a longer frame period than the sub image. Therefore, if the operation mode is simply switched between the write mode and the read mode every frame as with a usual method, there can be a period 1001 in which a collision between writing and reading can occur. To perform writing and reading in parallel, the data transfer rate needs to be increased to a value two times higher than the rate needed in a case where only either writing or reading is performed at a time. The increase in the data transfer rate causes an increase in complexity of a peripheral circuit associated with the memories.

### SUMMARY OF THE INVENTION

In an aspect, the present invention provides an image display apparatus including a display unit, a drive unit configured to drive the display unit, and an image processing unit configured to output an image signal, based on an input signal, to the drive unit, the image signal includes a signal of a first image and a signal of a second image obtained by processing an original image based on the input signal, and wherein the image processing unit converts a horizontal synchronization signal and a vertical synchronization signal associated with the input signal into a horizontal synchronization signal and a vertical synchronization signal associated with the signal of the first image and the signal of the second image, writes the image signal into each of at least two frame memories in synchronization with the unconverted vertical synchronization signal, reads out the image signal from each frame memory in synchronization with the converted vertical synchronization signal, and switches, in a period in which a vertical blanking period associated with the unconverted vertical synchronization signal overlaps a vertical blanking period associated with the converted vertical synchronization signal, an operation mode of each frame memory between writing and reading.

Thus, the image display apparatus according to the aspect of the invention can be realized in a small-sized form at low cost with the capability of suppressing a reduction in image quality without increasing a frame memory transfer rate.

Further features of the present invention will become apparent from the following description of exemplary embodiments with reference to the attached drawings.

### BRIEF DESCRIPTION OF THE DRAWINGS

FIG. 1 is a block diagram illustrating a configuration of a time dividing block.

FIG. 2 is a timing chart illustrating timings of signals associated with a time dividing block.

FIG. 3 is a block diagram illustrating a configuration of an image display apparatus according to an embodiment of the present invention.

FIGS. 4A to 4D are timing charts illustrating timings of driving waveforms.

FIGS. 5A and 5B are timing charts illustrating timings of signals associated with a frame conversion circuit.

FIG. 6 is a block diagram illustrating a circuit configuration of a memory control circuit.

FIG. 7 is a timing chart illustrating timings of signals associated with a time dividing block.

FIG. 8 is a block diagram illustrating a configuration of a luminance distributing block.

FIGS. 9A and 9B are timing charts illustrating timings of signals associated with luminance distributing block.

FIG. 10 is a timing chart illustrating timings of writing/reading data into/from a memory.

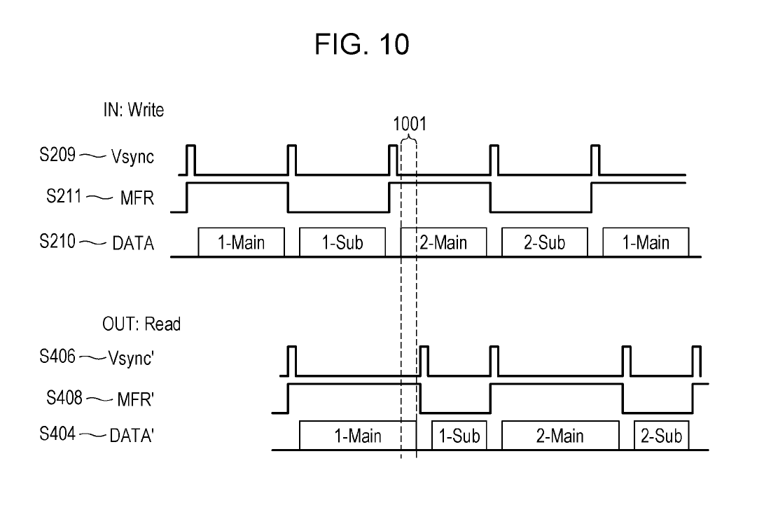

### DESCRIPTION OF THE EMBODIMENTS

According to an embodiment of the present invention, an image display apparatus includes a display panel (a display unit), a driving circuit (a drive unit) configured to supply a driving signal to the display panel to displaying an image, an image processing circuit (an image processing unit) configured to convert input image data into an image signal in a form capable of being handled by the display panel, and a timing controller configured to control timings associated with displaying. The image processing circuit generates an image signal for a plurality of frames including a main image frame (main frame) and a sub image frame (sub frame) based on one frame of input image data (input signal). The sub image has the same content as that of the main image and has N frames (N is a positive integer) with luminance lower than that of the main image. The main image and the sub images having the same content as that of the main image are obtained by producing the main image and the sub image from the same input image data or one set of input image data such that image brightness and frequency components are different between the main image and the sub images. Therefore, there is substantially no image motion between the main image and the sub images. The image processing circuit sets horizontal scanning periods of the main frame and the sub frames such that the main frame has a longer horizontal scanning period than the sub frames. The conversion of the horizontal scanning periods (1H) causes corresponding changes to occur in the respective frame periods, and thus the write/read timing associated with frame memories is switched in the vertical blanking period.

As for the display panel, either the impulse-type display apparatus or the hold-type display apparatus may be employed. To achieve a less reduction in luminance, the impulse-type display apparatus may be employed. In the impulse-type display apparatus, pixels arranged in the form of a matrix are line-sequentially addressed. When a particular pixel is addressed, the pixel emits light. After the addressing to the pixel is ended, the luminance decays. In this manner, one frame of image is formed. Specific examples of display panels include a field emission display, a DLP (Digital Light Processing) display, etc.

The input image data is converted into image data including sets of frames such that each set includes a main frame and N sub frames (first and second embodiments). In an alternate embodiment (third embodiment), the input image data may be converted into simple image data in which the image is simply expressed by a series of frames without being discriminated between main frames and sub frames. The main image and sub images are divided images obtained from the input image data by reducing the luminance of the original image by different reduction rates. This method of driving the display such that one frame of image is divided (distributed) into a plurality of frames with different luminance is referred to as “luminance distribution”.

In the embodiments, the display apparatus is assumed to be of the impulse type in which the gray level is represented by pulse-width modulation of a modulating signal, and a perceivable disturbance in a moving image is suppressed by setting the sub images to have lower luminance than the luminance of the main image (note that the luminance of the main image and the luminance of the sub images are lower than the luminance of the original image). The maximum absolute rating of the amplitude of the modulating signal is determined by a characteristic specific to the display. Therefore, to obtain higher luminance, it is necessary to increase the distributed pulse width. In the embodiments of the invention, each frame period (1H) is assigned a proper value (corresponding to a time-divided period) such that the value of 1H of a main frame is greater than the value of 1H of sub frames while maintaining the total frame period constant.

### First Embodiment

A first embodiment is described below. In this first embodiment, a set of frames of an image signal is assumed to include one main frame and one sub frame (N=1). A display panel is driven at a rate (at a frame frequency of 120 Hz) two times the normal rate (at a frame frequency of 60 Hz) employed for a case in which no frame division is performed.

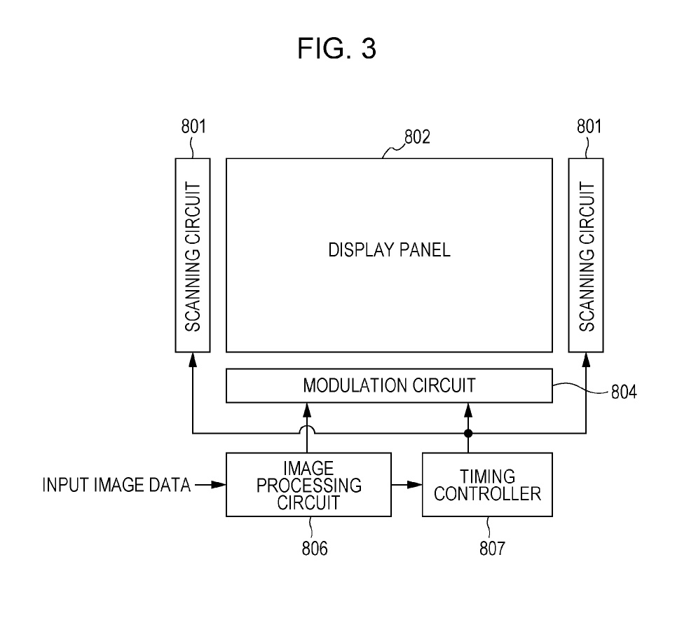

FIG. 3 is a block diagram illustrating an image display apparatus according to the present embodiment of the invention. The display panel 802 includes pixels arranged in the form of a matrix. The pixels are line-sequentially driven by a driving circuit including a scanning circuit 801 and a modulation circuit 804. The scanning circuit 801 outputs a scanning signal over scanning lines disposed on the display panel 802. The modulation circuit 804 outputs a modulating signal based on the image signal over signal lines disposed on the display panel 802. The image processing circuit 806 outputs the image signal based on the input image data to the modulation circuit 804 and also outputs a synchronization signal converted from an input synchronization signal to a timing controller 807. According to the converted synchronization signal, the timing controller 807 controls the timing of outputting driving signals (the scanning signal and the modulating signal) from the driving circuit to the display panel 802.

The gray level of the image displayed on the display panel 802 is controlled by changing the pulse with of the modulating signal applied to the display panel 802 during one horizontal scanning period.

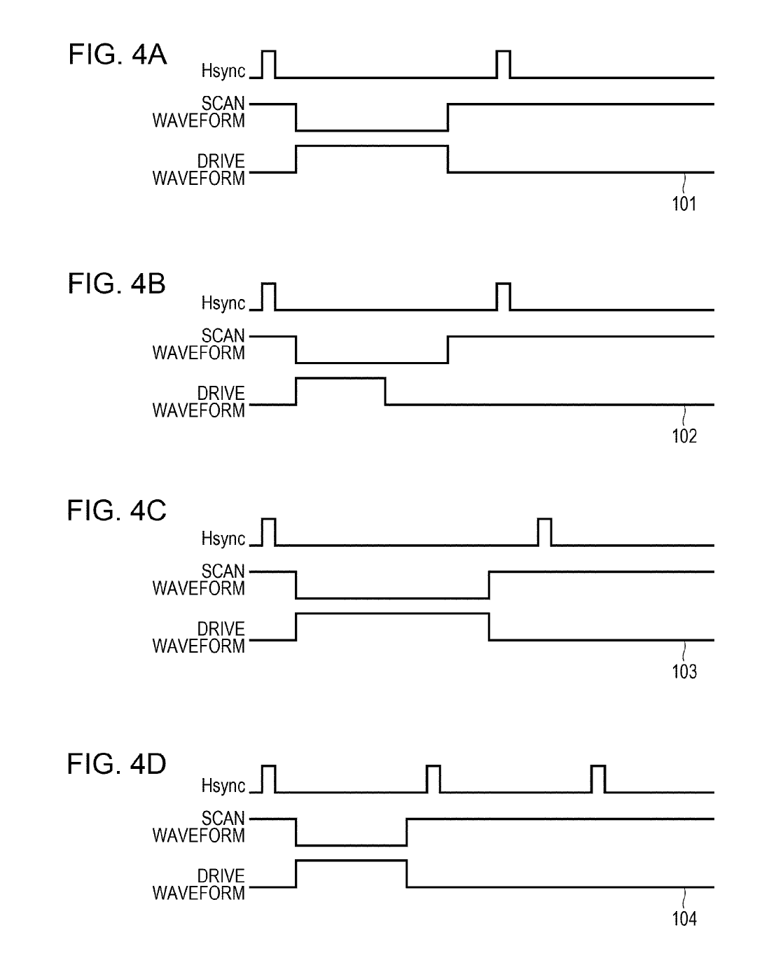

A description is given below as to driving waveforms employed in the time division driving scheme. FIGS. 4A to 4D illustrate timings of applying horizontal synchronization signals (Hsync), scanning signals (Scan Waveform), and modulating signals (Drive Waveform). FIGS. 4A and 4B illustrate driving waveforms for a case in which the time division driving scheme is not used. In this case, the main frame and the sub frame are driven by scanning signals with the same pulse width.

FIGS. 4C and 4D illustrate driving waveforms for a case in which the time division driving scheme is used. In this case, the pulse width of the scanning signal that drives the sub frame is set to be different from that pulse width of the scanning signal that drives the main frame such that the value of 1H is different for the main frame and the sub frame thereby making it possible for the modulating signal to be modulated in a wider range of pulse width. That is, the value of 1H for the main frame can be expanded depending on the value of 1H for the sub frame in which the sub image with luminance limited to a low range is displayed.

The sum of the value of 1H for the main frame and the value of 1H for the sub frame is equal to the value of 1H of the input image data. That is, when the value of 1H for the main frame is increased, the value of 1H for the sub frame is reduced by an amount corresponding to the amount of increase in 1H for the main frame such that the sum thereof is maintained equal to the value of 1H of the input image data. Furthermore, vertical blanking periods are adjusted such that the sum of the main frame period and the sub frame period is equal to the frame period of the input image data.

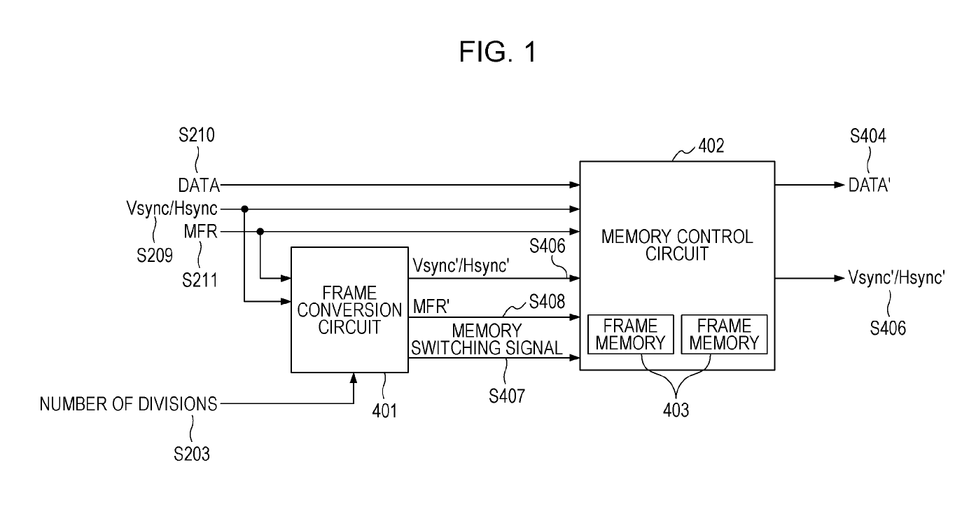

A circuit configuration for setting the frame periods is described below. FIG. 1 illustrates a time dividing block in the image processing circuit 806. A frame conversion circuit 401 receives a synchronization signal (Vsync/Hsync) S209, an MFR signal S211, and data indicating the number of divisions S203 supplied from the outside. The number of divisions is equal to the sum of the number of main frames and the number of sub frames. For example, in a case where an image signal includes one main frame and N sub frames, the number of divisions is equal to N+1. In the present embodiment, N=1 and thus number of divisions=2. The MFR signal is an identification signal identifying the main frame and the sub frame. The MFR signal rises up to the H (high) level when the vertical synchronization signal Vsync rises up to indicate the start of the main frame, and the MFR signal falls down to the L (low) level when the vertical synchronization signal Vsync rises up to indicate the start of the sub frame.

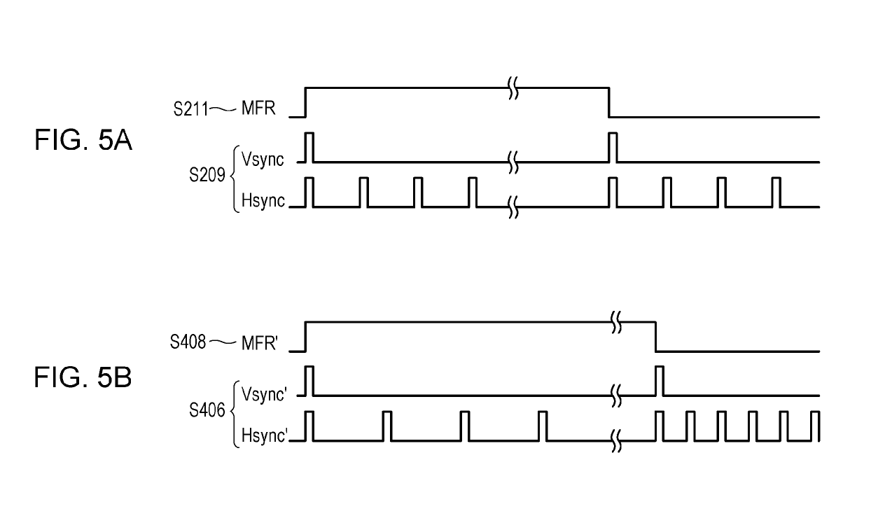

The frame conversion circuit (conversion unit) 401 sets the value of 1H for the main frame and the value 1H for the sub frame, respectively, (i.e., the frame conversion circuit 401 sets the duty of the horizontal synchronization signal) according to the luminance ratio between the main image and the sub image. FIG. 5A illustrates signals input to the frame conversion circuit 401, and FIG. 5B illustrates corresponding signals output from the frame conversion circuit 401. The maximum pulse width needed to display the main image and that needed to display the sub image are determined from the luminance of the main image and that of the sub image, and thus the required values of 1H are determined. In the present embodiment, it is assumed that the relationship between the number of divisions and the ratio of the luminance of the main image to the luminance of the sub image is defined in advance. The frame conversion circuit 401 sets the value of 1H for each frame according to the number of divisions and outputs corresponding time-divided synchronization signals (Vsync′/Hsync′) and time-divided MFR signal (MFR′). Note that, based on the MFR signal, the frame conversion circuit 401 determines whether frame data given as input image data is frame data of a main image or frame data of a sub image. The time-divided synchronization signals (Vsync′/Hsync′) and the time-divided MFR signal (MFR′) are supplied to a memory control circuit 402. These signals are used by the memory control circuit 402 to controls frame memories (described later) in terms of the read timing. The frame conversion circuit 401 also produces a memory switching signal S407, which will be described later, and supplies it to the memory control circuit 402.

The relationship between the number of divisions and the value of 1H may be determined by referring to a table. Alternatively, the value of 1H may be directly specified by a user, or the value of 1H may be dynamically determined based on the maximum luminance detected in a frame.

The memory control circuit 402 (memory control unit) receives frame data (DATA) S210 of a main image and a sub image of input image data, input in synchronization with the unconverted vertical synchronization signal, and the memory control circuit 402 outputs output image data (DATA′) S404 in synchronization with the converted vertical synchronization signal provided by the frame conversion circuit 401. The memory control circuit 402 also outputs synchronization signals (Vsync′/Hsync′) S406 converted by the frame conversion circuit 401. The frame periods of the input main image and the sub image are different from those of output image data. To handle this difference, the frame rate conversion is performed using the frame memories. More specifically, one frame of frame data of the input image data is all stored once in a frame memory 403 and then read therefrom in synchronization with the time-divided synchronization signals (Vsync′/Hsync′) S406 thereby providing the output image data.

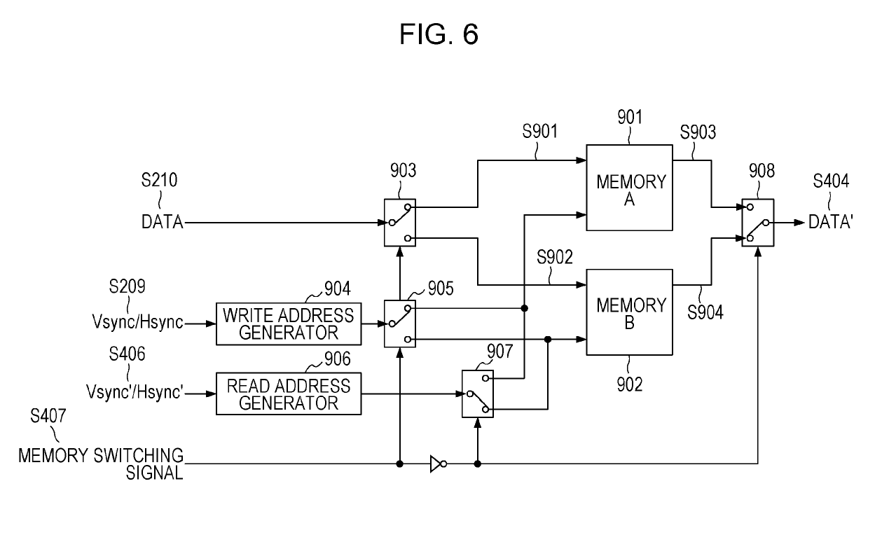

The manner of controlling the frame memory is described in further detail below. FIG. 6 is a block diagram illustrating the details of the memory control circuit 402. A write address generator 904 generates a write address based on the input synchronization signals (Vsync/Hsync) S209 (which is set such that the frame period is equal for the main frame and the sub frame, and the value of 1H is equal for the main frame and the sub frame). A read address generator 906 generates a read address based on the synchronization signal (Vsync′/Hsync′) S406 generated by the frame conversion circuit 401. During a period in which the memory switching signal S407 is at the L level, the input image data is written in a memory A 901, while data is read from a memory B 902 and output as output image data. Conversely, during a period in which the memory switching signal is at the H level, the input image data is written in the memory B 902, while data is read from the memory A 901 and output as output image data. A control circuit (not shown in the figure) controls a write data selector 903, a write address selector 905, a read address selector 907, and a read data selector 908. The control circuit controls the frame conversion circuit 401 such that the memory switching signal is toggled every two frames when an address period determined by the write synchronization signal and an address period determined by the read synchronization signal are both in a vertical blanking period. That is, in a period in which the vertical blanking period associated with the unconverted vertical synchronization signal overlaps a vertical blanking period associated with the converted vertical synchronization signal, the operation mode of each frame memory is switched between writing and reading. The memory A 901 and the memory B 902 each have a storage capacity that allows it to store one set of image data including a main frame and a sub frame.

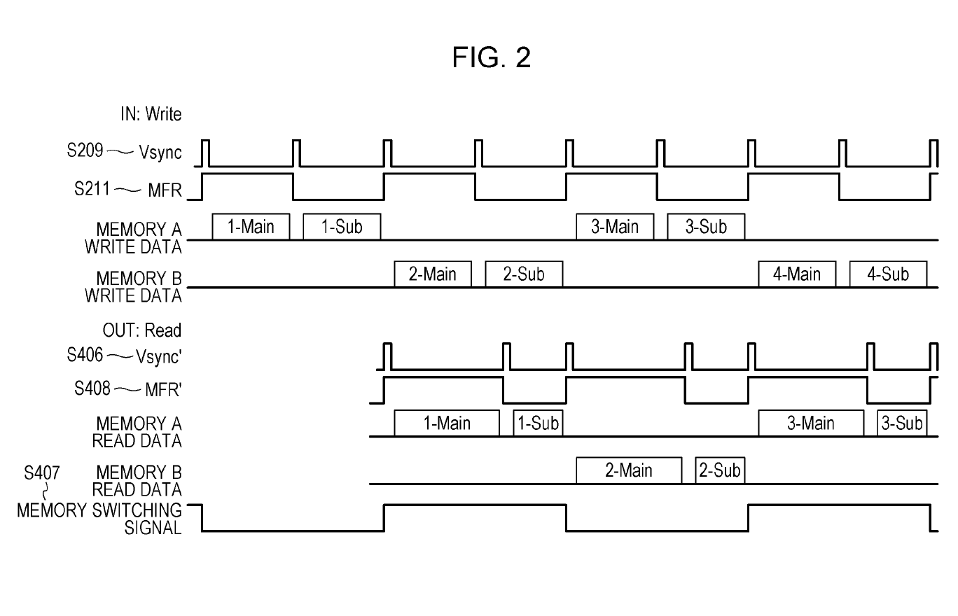

The operation is described in further detail below with reference to a timing chart shown in FIG. 2. First, in the period in which the memory switching signal is at the L level, main image data (1-Main) and sub image data (1-Sub) that are input as first frame data of the input image data are written in the memory A 901. After two frames of image data are input, the memory switching signal is switched to the H level in a vertical blanking period following the sub image (1-Sub). Subsequently, if second input frame data including main image data (2-Main) and sub image data (2-Sub) is given, this data is written in the memory B 902, because the memory switching signal is at the H level. At the same time, the main image data (1-Main) and the sub image data (1-Sub) of the first input frame data written in the previous processing step are read from the memory A 901 and output as output image data from the time dividing block. After the two frames of image described above have been input, the memory switching signal is again switched to the L level, and the above-described process is repeated. The writing and the reading are performed in parallel for the respective frame memories such that when one frame memory is in the writing mode or the reading mode, the other frame memory is in the other operation mode and such that the writing operation and the reading operation of the respective frame memories are synchronous in units of two frames as described above, no collision occurs between the reading process and the writing process. Furthermore, when a particular frame of image signal is being written in one frame memory, it is allowed to read a previous frame of image signal from the other frame memory. This makes it possible to write/read frame data of respective divided images without increasing the transfer rate of the frame memories.

The memory switching signal may be toggled every particular number of frames depending on the storage capacity of memories such that the writing operation and the reading operation of the respective frame memories are switched in synchronous with the toggling of the memory switching signal. Although in the previous embodiment the frame data is output in accordance with the vertical synchronization signal Vsync and the horizontal synchronization signal Hsync, the outputting of the frame data may be controlled in accordance with a DE (Data Enable) signal.

### Second Embodiment

In a second embodiment, a process is disclosed for a case in which a plurality of sub image frame data are input (for example, N=3 and the display panel is driven at a rate four times higher than the normal rate). A duplicated explanation of similar functions or configurations to those according to the first embodiment is omitted.

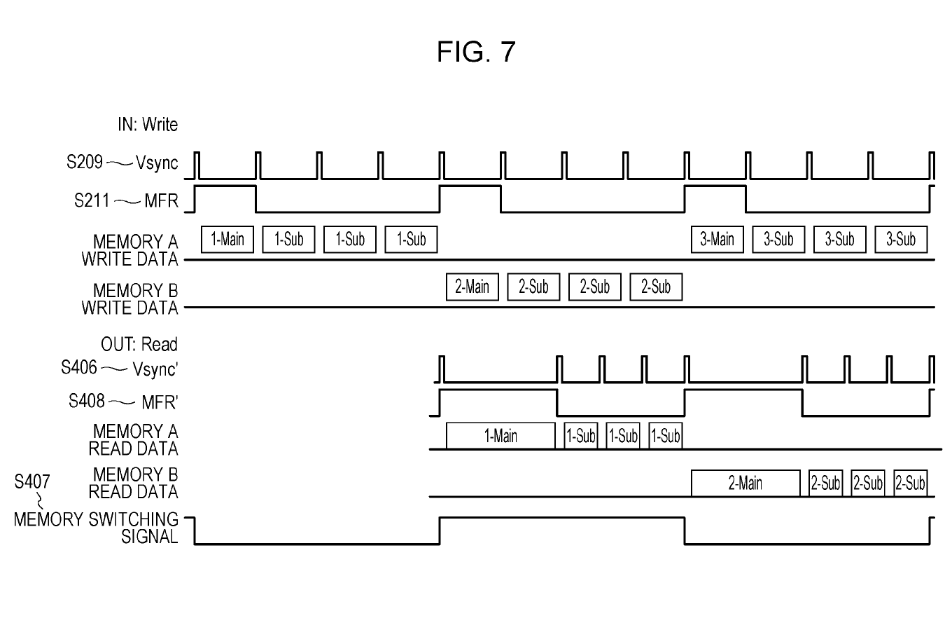

A time dividing block is configured in a similar manner to that according to the first embodiment. Frame data (DATA) S210 of main/sub image, synchronization signals (Vsync/Hsync) S209, and data indicating the number of divisions S203 are input to the time dividing block. As in the first embodiment, the time dividing block determines the value of 1H for each frame of divided images and outputs frame data of each divided image and a converted synchronization signal. However, the present embodiment is different in that the switching between the reading mode and the writing mode for each memory is performed every four frames as shown in FIG. 7 to prevent a collision between the reading operation and the writing operation. The written image data is read with a delay corresponding to four frames.

### Third Embodiment

A third embodiment discloses a process of producing one main image frame and N sub image frames from one input image data. In particular, a description is given for a specific case where the display panel is driven at a rate two times higher than the normal rate (N=1). A duplicated explanation of similar functions or configurations to those according to the first or second embodiment is omitted.

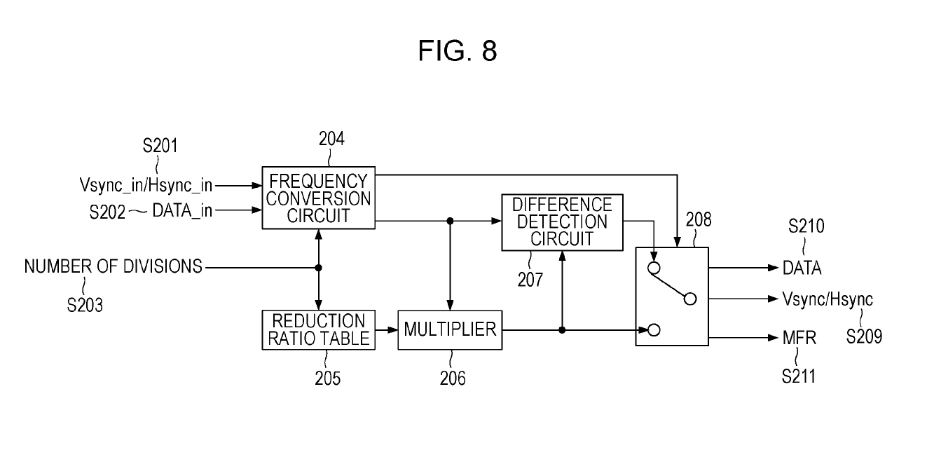

FIG. 8 illustrates a luminance distributing block of an image processing circuit 806. The luminance distributing block determines the reduction rate for the main image and that for the sub image based on the number of frames to be produced from one frame of the input image data (i.e., based on the number of divisions S203). The number of divisions S203 may be set in advance or may be set by a user. In the present embodiment, it is assumed that the number of divisions S203 is set in advance to two. The frame data of the main image and that of the sub image are produced according to the determined reduction rates.

First, input image data (DATA_in) S202 and input synchronization signals (Vsync in/Hsync in) S201 are input to a frequency conversion circuit 204. Furthermore, data indicating the number of divisions S203 is input to the frequency conversion circuit 204 and a reduction rate table 205. The frequency conversion circuit 204 converts the frame frequency according to the number of divisions. In the present embodiment, the frame frequency is converted to a value twice the original value associated with the input image data. The reduction rate table 205 describes the luminance ratio between the main image and the sub image as a function of the total number of frames (i.e., the number of divisions) in a set of frames including a main frame and N sub frames. More specifically, the reduction rate table 205 describes the relationship between the number of divisions and the reduction rate of the sub image.

The frequency conversion circuit 204 outputs the frequency-converted synchronization signals (Vsync/Hsync) S209 (with a duty one-half the duty of the input synchronization signal) to a switch circuit 208. Furthermore, the frequency conversion circuit 204 supplies the input image data (DATA_in) S202 to a difference detection circuit 207 and a multiplier circuit 206. The reduction rate table 205 outputs a reduction rate (0.25) related to the number of divisions (=2) to the multiplier circuit 206.

The multiplier circuit 206 produces frame data of a sub image having luminance 0.25 times the luminance of the original image by multiplying each pixel value of the frame data (DATA_in) S202 of the input mage by the reduction rate. The resultant frame data of the sub image is output to a difference detection circuit 207 and a switch circuit 208.

The difference detection circuit 207 produces frame data of the main image by subtracting the frame data of the sub image from the frame data (DATA_in) S202 of the input image. The resultant frame data of the main image having luminance 0.75 times that of the original image is output to the switch circuit 208.

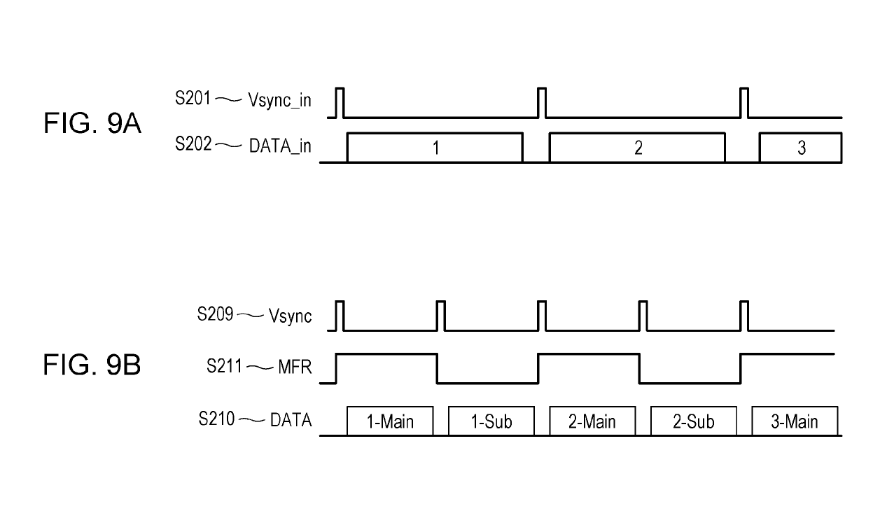

The switch circuit 208 switches the frame data output therefrom according to the synchronization signals (Vsync/Hsync) S209. The switch circuit 208 also outputs the synchronization signals (Vsync/Hsync) S209 and an MFR signal S211 indicating whether the output frame data is of the main image or of the sub image. The MFR signal S211 changes in level in synchronization with the vertical synchronization signal Vsync such that it switches to the H level immediately responding to a rise indicating the start of a main frame while it switches to the L level immediately responding to a rise indicating the start of a sub frame. FIGS. 9A and 9B illustrate timings of signals associated with the luminance distributing block.

Note that the reduction rate and/or the luminance ratio between the main image and the sub image may be input from the outside (may be set by a user) or may be calculated on a frame-by-frame basis based on the feature of the input image data (DATA_in) S202. The frame data of the main image may be generated based on the reduction rate of the main image. In this case, the reduction rate for each frame may be set such that the sum of values of 1H for the respective frames of divided images does not exceed the value of 1H of the frame of the input image data (DATA_in) S202.

Experiments performed by the present inventors show that when the ratio of luminance of the main image to that of the sub image is equal to or greater than 1.2, a perceptible disturbance in a moving image can be suppressed. Furthermore, in practice, the display panel is designed such that the value of 1H for the main frame is smaller than five times the value of 1H for the sub frames. Thus, the luminance ratio may be set in a range from 1.2 to 5.0 to achieve a good result.

The configuration of the time dividing block may be similar to that according to the first or second embodiment. The frame data (DATA) S210 of the divided images produced by the luminance distributing block is input to the memory control circuit 402. The synchronization signals (Vsync/Hsync) S209 and the MFR signal S211 produced by the luminance distributing block, and also the data indicating the number of divisions S203, are input to the frame conversion circuit 401. Thus, as with the first embodiment, frame data of time-divided images is obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-185288 filed Aug. 20, 2010, which is hereby incorporated by reference herein in its entirety.

What is claimed is:

1. An image display apparatus comprising:
a display unit;
a drive unit configured to drive the display unit; and
an image processing unit configured to output an image signal, based on an input signal, to the drive unit,
wherein the image signal includes a signal of a first image and a signal of a second image obtained by processing an original image based on the input signal,
and wherein the image processing unit converts a horizontal synchronization signal and a vertical synchronization signal associated with the input signal into a horizontal synchronization signal and a vertical synchronization signal associated with the signal of the first image and the signal of the second image, writes the image signal into each of at least two frame memories in synchronization with the unconverted vertical synchronization signal, reads out the image signal from each frame memory in synchronization with the converted vertical synchronization signal, and switches, in a period in which a vertical blanking period associated with the unconverted vertical synchronization signal overlaps a vertical blanking period associated with the converted vertical synchronization signal, an operation mode of each frame memory between writing and reading.

2. The image display apparatus according to claim 1, wherein the image processing unit writes and reads the image signal such that when an image signal of one frame is being written into one frame memory, an image signal of the previous frame is read out from the other frame memory.

3. The image display apparatus according to claim 1, wherein the image processing unit divides one frame of the input signal into sub-frames and produces an image signal comprising a sub-frame of the first image and a sub-frame of the second image.

4. An image display apparatus comprising:
a display unit;
a drive unit configured to drive the display unit; and
an image processing unit configured to output an image signal, based on an input signal, to the drive unit,
wherein the image signal includes a signal of a main image with lower luminance than the luminance of an original image based on the input signal and a signal of a sub image with lower luminance than the luminance of the main image,
and wherein the image processing unit converts a horizontal synchronization signal and a vertical synchronization signal depending on the ratio between the luminance of the main image and the luminance of the sub image such that the horizontal scanning period of a frame of the main image is longer than the horizontal scanning period of a frame of the sub image, writes the image signal into at least two frame memories in synchronization with the unconverted vertical synchronization signal, reads out the image signal from the respective frame memories in synchronization with the converted vertical synchronization signal, and switches, in a period in which a vertical blanking period associated with the unconverted vertical synchronization signal overlaps a vertical blanking period associated with the converted vertical synchronization signal, an operation mode of each frame memory between writing and reading.

5. The image display apparatus according to claim 4, wherein the image processing unit converts the synchronization signal of each frame such that the sum of a frame period of the main image and a frame period of the sub image is equal before and after the conversion.

6. The image display apparatus according to claim 4, wherein the input signal includes the signal of the main image, the signal of the sub image, and an identification signal identifying the signal of the main image and the signal of the sub image,
and wherein the image processing unit sets the ratio between the luminance of the main image and the luminance of the sub image based on the identification signal.

7. A method controlling image display apparatus including a display unit, a drive unit configured to drive the display unit, and an image processing unit configured to output an image signal, based on an input signal, to the drive unit, wherein the image signal includes a signal of a first image and a signal of a second image obtained by processing an original image based on the input signal, the method comprising the steps, performed in the image processing unit, of:
converting a horizontal synchronization signal and a vertical synchronization signal associated with the input signal into a horizontal synchronization signal and a vertical synchronization signal associated with the first image signal and the second image signal;
writing the image signal into each of at least two frame memories in synchronization with the original unconverted vertical synchronization signal;
reading out the image signal from each frame memory in synchronization with the converted vertical synchronization signal; and
switching, in a period in which a vertical blanking period associated with the unconverted vertical synchronization signal overlaps a vertical blanking period associated with the converted vertical synchronization signal, an operation mode of each frame memory between writing and reading.
